(19) United States
(12) Patent Application Publication
(10) Pub. No.: US 2008/0190512 A1
(43) Pub. Date: Aug. 14, 2008

(54) Storage Bag with Evacuation Device

(76) Inventor: Michael G. Borchardt, Naperville, IL (US)

Correspondence Address: THE CLOROX COMPANY, P.O. BOX 24305, OAKLAND, CA, 94623-1305, US

(21) Appl. No.: 11/720,042

(22) PCT Filed: Dec. 16, 2005
(86) PCT No.: PCT/US2005/045963

§ 371 Date: May 23, 2007

(30) Foreign Application Priority Data
Jun. 24, 2005 (US) 11166574

(51) Int. Cl. B65B 31/04; A23L 3/00; B65D 81/20

(52) U.S. Cl. 141/8; 141/65; 99/472; 206/524.8; 53/405

(57) ABSTRACT

A system includes a storage bag having an interior volume for containing food items and a one-way valve element through which air from the interior volume can be evacuated. The system further includes an evacuation device having an inlet opening. To evacuate storage bag, the inlet opening is placed directly adjacent a pliable sidewall of the storage bag about the valve element. The placement of the inlet opening against the flexible sidewall will seal the interface between the valve element and the inlet opening facilitating the evacuation of the interior volume.

### CROSS-REFERENCE TO RELATED APPLICATIONS

This application is a continuation in part of co-pending U.S. patent application Ser. No. 11/039,735, filed Jan. 20, 2005, herein incorporated by reference in its entirety.

### FIELD OF THE INVENTION

This invention pertains generally to storage containers and more particularly to flexible, thermoplastic, storage bags designed to be sealed and evacuated. The invention finds particular applicability in the field of food storage.

### BACKGROUND OF THE INVENTION

Storage bags are commonly used for a variety of purposes such as storing food items. Such storage bags are typically made from a flexible, low cost, thermoplastic material that defines an interior volume into which food items can be inserted. To preserve the inserted food, the storage bag may also include a distinct closing mechanism, such as interlocking fastening strips, for sealing closed an opening through which the interior volume is accessible.

One problem that occurs with the aforementioned storage bags is that latent air may remain trapped within the interior volume after sealing closed the opening. The trapped air may cause spoiling or dehydration of the food items. To remove the trapped air, it is known to provide a one-way valve element or other evacuation device communicating with the interior volume. The one-way valve element allows for the evacuation of trapped air while preventing the ingress of air from the surrounding volume into the interior volume. The one-way valve element may be activated in various ways such as, for example, by applying compressive pressure to the flexible sidewalls to force air from the interior volume or by engaging a nozzle of a vacuum source to the one-way valve element to draw air from the interior volume. Possible problems that may arise when engaging the nozzle to the valve element include the potential for misalignment and incapability of forming a sufficient seal between the nozzle and valve element.

Often, the stored food items contain fluids or juices that, during evacuation, may be drawn into and thereby contaminate the valve element. As will be appreciated, the contaminated valve element may result in sanitary issues and may not function properly. Additionally, the fluids or juices may also be drawn through the valve element and into the vacuum source or otherwise ejected into the environment, causing additional sanitary or operational problems. The inventive storage bag remedies these and other problems.

### BRIEF SUMMARY OF THE INVENTION

In an aspect, the invention provides a storage bag configured with a separator that causes separation of fluids and juices from air being evacuated through the one-way valve element. The valve element communicates with the interior volume via the separator such that evacuating air must pass through the separator. By removing fluids and juices from the evacuating air before the air passes through the one-way valve element, contamination of the valve element is avoided.

In another aspect of the invention, the separator is configured as an excess piece of flexible material that sealingly connects the valve element to a smooth sidewall of the storage bag. The flexible separator is adjustable between a collapsed position and an expanded position. In the collapsed position, the valve element is generally located within the plane of the sidewall to enable compact stacking and folding of multiple bags. In the expanded position, the separator expands to define a chamber that raises or spaces the valve element from the sidewall. As air is drawn through the chamber, fluids and juices are caused to gravitationally separate from the evacuating air, condense together, and are returned to the interior volume.

In yet another aspect, the invention provides a system for storing items such as food stuffs in a storage bag. The system includes a storage bag made from a flexible or pliable sidewall that provides an interior volume and a one-way valve element attached to the sidewall and communicating with the interior volume. To evacuate the interior volume, the system also includes an evacuation device having a nozzle with an inlet opening that is configured to be placed against the sidewall about the valve element. Because of its flexible characteristics, the pliable sidewall can be drawn or stretched against the rigid inlet opening to seal the inlet opening from air in the surrounding environment. As will be appreciated, the sealed interface between the inlet opening and the valve element will facilitate removing gases from the interior volume when the evacuation device is activated.

An advantage of the invention is that it provides a storage bag configured to prevent contamination of a one-way valve element by separating fluids from evacuating air. Another advantage is that, in an aspect, the bag including the separator is made from flexible material to allow collapsing and folding of the bag for compact packaging during distribution. Another advantage is that, in an aspect, the invention provides a system that establishes an improved interface between the valve element and the evacuation device. These and other advantages and features of the invention will become apparent from the detailed description and the accompanying drawings.

### BRIEF DESCRIPTION OF THE DRAWINGS

FIG. 1 is a perspective view of a storage bag designed in accordance with the teachings of the invention, the storage bag having a one-way valve element and a separator for separating fluids and juices from evacuating air.

FIG. 2 is a cross-sectional view through the valve element and the separator as taken along line 2-2 of FIG. 1, the valve element and separator being acted upon by a nozzle during evacuation and the separator shown in an expanded position.

FIG. 3 is a cross-sectional view through the valve element and the separator as taken along line 3-3 of FIG. 1, the separator shown in a collapsed position.

FIG. 4 is an exploded view of another embodiment of a storage bag having a one-way valve element and a separator for separating fluids and juices from evacuating air.

FIG. 5 is a cross-sectional view through the valve element and separator taken along line 5-5 of FIG. 1, the valve element and separator being acted upon by a nozzle during evacuation and the separator shown in an expanded position.

FIG. 6 is a cross-sectional view through the valve element and the separator as taken along line 6-6 of FIG. 4, the separator shown in a collapsed position.

FIG. 7 is a cross-sectional view of another embodiment of the storage bag as taken through the valve element and the separator as being acted upon by a nozzle during evacuation, the separator shown in the expanded position.

FIG. 8 is a cross-sectional view of the embodiment of the storage bag illustrated in FIG. 7 as taken through the valve element and the separator, the separator shown in the collapsed position.

FIG. 9 is a perspective view of another embodiment of the storage bag having a one-way valve element and a separator for separating fluids and juices from evacuating air, where the separator is provided by forming opposing Z-folds into the sidewall of the bag.

FIG. 10 is a detailed view of the indicated portion of FIG. 9, illustrating the arrangement of the opposing Z-folds.

FIG. 11 is a cross-sectional view through the valve element and separator taken along line 11-11 of FIG. 9 with the separator shown in the collapsed position.

FIG. 12 is a cross-sectional view through the valve element and separator taken along line 12-12 of FIG. 9 with the separator shown in the expanded position.

FIG. 13 is a perspective view of another embodiment of a storage bag with a one-way valve element and an evacuation device for evacuating the storage bag.

FIG. 14 is a cross-sectional view taken along line 14-14 of the storage bag of FIG. 13 further showing the inlet opening of the evacuation device placed about the valve element.

FIG. 15 is a front perspective view of an embodiment of a one-way valve element for use with flexible bags of the invention.

FIG. 16 is a rear perspective view of the one-way valve element of FIG. 15.

FIG. 17 is a cross-sectional view through the one-way valve element, as taken along line 17-17 of FIG. 15.

FIG. 18 is an exploded view of another embodiment of the one-way valve element for attachment to the flexible bag.

FIG. 19 is an exploded view of another embodiment of the one-way valve element for attachment to the flexible bag.

FIG. 20 is a cross-sectional view of a valve element attached to a storage bag having a barrier element for separating fluids and juices from evacuating air.

FIG. 21 is a front elevational view of a storage bag configured with a porous layer extending over a hole disposed through the sidewall.

FIG. 22 is a front elevational view of a storage bag configured with a porous layer and a non-porous layer extending over a hole disposed through the sidewall.

FIG. 23 is an enlarged plan view of an embodiment of the porous and non-porous layers of FIG. 22.

FIG. 24 is an enlarged plan view of another embodiment of the porous and non-porous layers of FIG. 22.

### DETAILED DESCRIPTION OF THE INVENTION

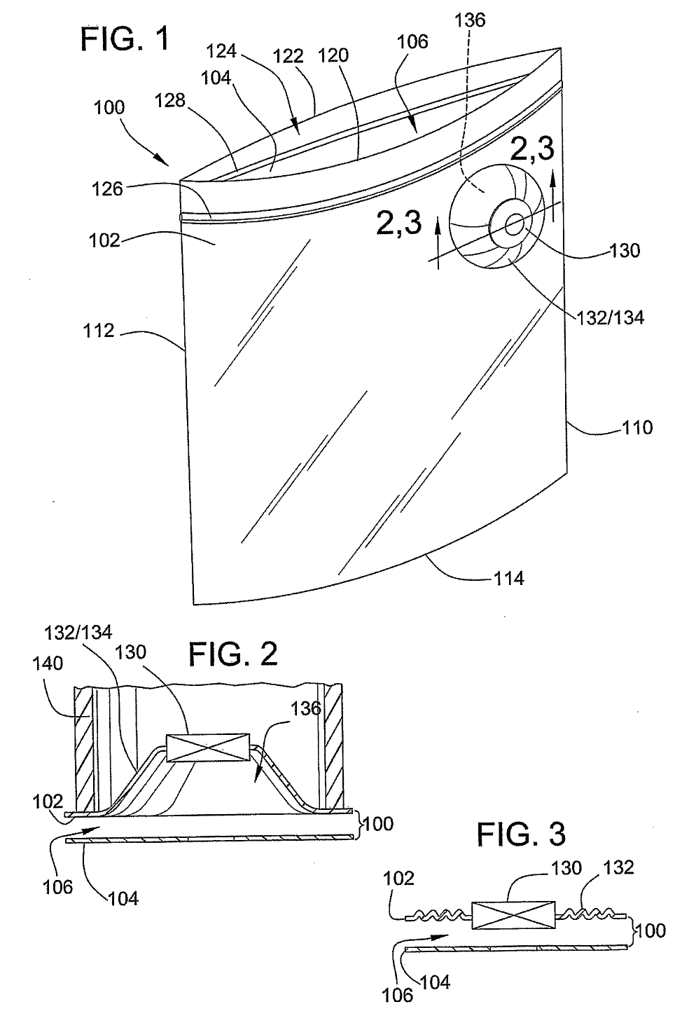

Now referring to the drawings, wherein like reference numbers refer to like elements, there is illustrated in FIG. 1 a storage bag 100 for storing items such as food stuffs. In the illustrated embodiment, the storage bag 100 is made from a first sidewall 102 and an opposing second sidewall 104 overlying the first side wall to define an interior volume 106 therebetween. The first and second sidewall 102, 104 are joined along a first side edge 110, a parallel or non-parallel second side edge 112, and a closed bottom edge 114 that extends between the first and second side edges. The first and second sidewalls 102, 104 are preferably made from a flexible or pliable thermoplastic material formed or drawn into a smooth, thin walled sheet. Examples of suitable thermoplastic material include high density polyethylene, low density polyethylene, polypropylene, ethylene vinyl acetate, nylon, polyester, polyamide, ethylene vinyl alcohol, and can be formed in single or multiple layers. The thermoplastic material can be transparent, translucent, opaque, or tinted. Furthermore, the material used for the sidewalls can be a gas impermeable material. The sidewalls 102, 104 can be joined along the first and second side edges 110, 112 and bottom edge 114 by any suitable process such as, for example, heat sealing.

For accessing the interior volume 106, the top edges 120, 122 of the first and second sidewalls 102, 104 opposite the bottom edge 114 remain un-joined to define an opening 124. To seal closed the opening 124, first and second interlocking fastening strips 126, 128 can be attached to the interior surfaces of the respective first and second sidewalls 102, 104. The first and second fastening strips 126, 128 extend generally between the first and second side edges 110, 112 parallel to and spaced below the top edges 120, 122. In other embodiments, the bag 100 can include a movable slider straddling the fastening strips 126, 128 to facilitate occluding and deoccluding of the opening 124. In other embodiments, instead of fastening strips, the first and second sidewalls can be configured with pressure sensitive or cold seal adhesives (such as those disclosed in U.S. Pat. No. 6,149,304, herein incorporated by reference in its entirety), heat-sealing, or cling, to seal the open top edge.

To evacuate the bag of latent or entrapped air after the opening has been sealed closed, a one-way valve element 130 is provided that communicates with the interior volume 106. In one embodiment, the one-way valve element 130 is configured to open under an applied pressure differential thereby allowing air from the interior volume 106 to escape and to close after elimination or reduction of the pressure differential thereby preventing the ingress of environmental air into the interior volume. In accordance with the invention, the one-way valve element is connected to the rest of the bag via a separator to separate fluids and juices from evacuating air.

As illustrated in FIGS. 1 and 2, the separator 132 is formed from a piece of excess material in the shape of a thin-walled dome 134 that is joined along its base to a first sidewall 102 and protrudes outward therefrom. The thin-walled dome 134 of excess material surrounds and defines an enclosed chamber 136 that communicates with the interior volume 106. The valve element 130 is sealingly joined to the apex of the dome 134 and is thereby connected to and spaced-apart from the first sidewall 102.

Referring to FIG. 2, air drawn or forced from the interior volume 106 must pass through the chamber 136 to reach and escape through the valve element 130. In the chamber 136, fluids and juices entrained in the evacuating air from the interior volume are removed by gravitational separation and returned to the interior volume 106. More specifically, the pressure, velocity, and generally vertical direction of the air being drawn or forced through the chamber 136 interact to cause the fluids and juices to condense into droplets that can remain in the chamber during evacuation and return under the influence of gravity to the interior volume 106. This is facilitated by the greater density of the fluids as compared to air and due to the resulting condensation droplets' inability to traverse the chamber. Additionally, contacting the evacuating air generally along the inner surfaces of the sidewalls 102, 104 and causing the evacuating air to turn towards the valve element 130 along the inner surface of the excess material making up the separator 132 facilitates separation and condensation of the fluids and juices. Hence, the evacuating air actually passing through the valve element 130 is relatively devoid of entrained fluids and juices in liquid or droplet form, thereby preventing contamination of the valve element. The size and shape of the chamber 136 can be optimized with respect to the shape of the interior volume 106, first sidewall 102, and valve element 130 to maximize the separation of fluids and juices.

Referring to FIGS. 2 and 3, to allow for folding and packaging of the storage bag 100, the separator 132 is preferably adjustable between a collapsed position and an expanded position. The separator 132 can be made from the same or similar flexible or pliable material as the first or second sidewalls 102, 104. When the bag 100 is placed atop a generally flat surface, the separator 132 can collapse from the dome shape and bunch or fold together about the valve element 130 so that the valve element is generally located within the plane of the first sidewall 102, as shown in FIG. 3. When the separator 132 is in the collapsed position, the chamber is by and large eliminated. Hence, the first and second sidewalls 102, 104 are generally parallel and can be pressed together to eliminate the interior volume 106 and flatten the bag 100. As will be appreciated, multiple flattened bags can be compactly stacked atop one-another for packaging and distribution.

In one embodiment, to make the separator 132 “pop-up” and thereby place the separator into its expanded position, referring back to FIG. 2, a pressure differential is applied across the first sidewall 102 proximate the valve element 130. The pressure differential can be generated by the same vacuum source used to evacuate air from the bag 100 or from a different vacuum source. Specifically, a generally tubular nozzle 140 is placed against the first sidewall 102 generally about the valve element 130 and the separator 132. The first end of the nozzle 140 can be pressed against the first sidewall 102 while the second end of the nozzle communicates with a vacuum source. When the vacuum source is activated, the pressure differential between the interior volume 106 and the nozzle 140 causes the separator 132 to expand and protrude in the shape of the thin-walled dome 134 from the first sidewall 102. The expanding separator 132 defines the chamber 136 that raises or spaces the valve element 130 apart from the first sidewall 102 and in which the separation of fluids and juices from the evacuating air occurs. After evacuation of the interior volume 106, the valve element 130 will close as the pressure differential is reduced or eliminated and the nozzle 140 can be removed. After removal of the nozzle, the separator 132 can be collapsed by vacuum from inside the bag or by external hand pressure to force the remaining air in the chamber 136 back into the interior volume. In other applications, it will be appreciated that, rather than using a nozzle and an attached vacuum source, evacuation of the interior volume can occur by pressing the first and second sidewalls together by hand thereby forcing air into and expanding the separator.

Referring to FIGS. 2 and 3, the excess material for the separator 132 is preferably provided from the same sheet of material as used for the first sidewall 102. For example, the pliable material of the first sidewall 102 can be stamped, thermoformed or otherwise displaced or formed to provide the dome-shape 134 of the separator 132. Hence, the separator 132 is integral with the first sidewall 102 and can likewise be made of any suitable thermoplastic material such as, for example, high density polyethylene, low density polyethylene, polypropylene, ethylene vinyl acetate, and can be formed in single or multiple layers.

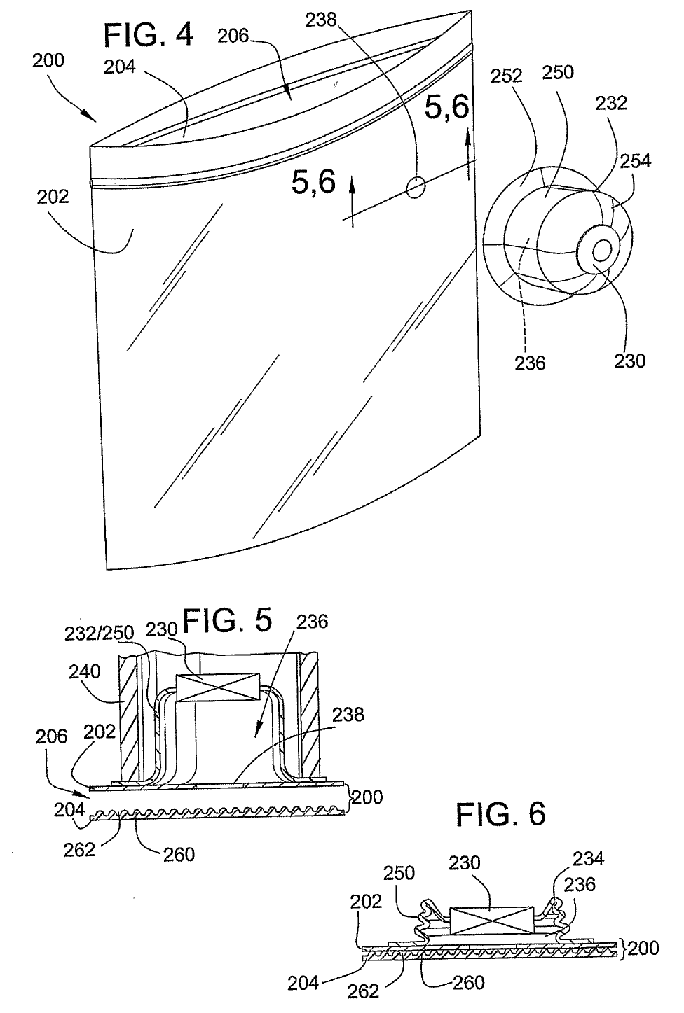

Referring to FIG. 4, there is illustrated another embodiment of a storage bag 200 wherein the separator 232 has a generally tubular shape and is formed separately from the material of the first sidewall 202. Specifically, in the illustrated embodiment, the separator 232 is formed as a cylindrically-shaped, tubular sleeve 250 of flexible or pliable thin-walled material that extends between a flanged base 252 and a closed cap 254. The sleeve 250 can be made from any suitable material including, for example, high density polyethylene, low density polyethylene, polypropylene, ethylene vinyl acetate, and can be formed in single or multiple layers. Moreover, the type of material can be the same as or different from the type of material used for the first and second sidewalls 202, 204. The tubular sleeve 250 defines and encloses a chamber 236 in which separation of fluids and juices from evacuating air can occur, as described above. The one-way valve element 230 is sealingly joined to the closed cap 254 to communicate with the chamber 236.

To operatively join the tubular-shaped separator 232 to the rest of the bag 200, a hole 238 is disposed through the first sidewall 202 to access the interior volume 206. The flanged base 252 is then placed against the first sidewall 202 so that the hole 238 aligns with the chamber 236 and the one-way valve element 230 is spaced-apart from the first sidewall. Any suitable method can be used to join the flanged base 252 to the first sidewall 202 including, for example, adhesives or heat sealing. Evacuating air from the interior volume 206 then passes across the hole 238 into the chamber 236 where separation occurs and exits through the valve element 230.

Referring to FIGS. 5 and 6, the tubular-shaped separator 232 is preferably configured to switch between an expanded position and a collapsed position for simplifying packaging and distribution. As illustrated in FIG. 6, in the collapsed position, the excess material comprising the tubular sleeve 250 bunches up about the valve element 230 which is generally adjacent the first sidewall 202. When the separator 232 is in the collapsed position, the chamber 236 is by and large eliminated. Additionally, the first sidewall 202 can be flattened against the second sidewall 204 to substantially eliminate the interior volume.

Referring to FIG. 5, to expand the separator 232 and recreate the chamber 236, a pressure differential is applied across the first sidewall 202 proximate the valve element 230. The pressure differential may be created by applying a nozzle 240 attached to a vacuum generating device about the valve element 230. When the vacuum generating device is activated, the evacuating air drawn through the hole 238 expands the separator 232 into the tubular sleeve 250 thereby lifting and spacing the valve element 230 from the first sidewall 202. Hence, fluids and juices entrained in the evacuating air can be separated by the process described above within the chamber 236 before the air exits through the one-way valve element 230.

As illustrated in the embodiment of FIGS. 5 and 6, the bag 200 can include other features to facilitate evacuation of air from the interior volume 206. For example, the interior surface of the second sidewall 204 can include a plurality of elongated ribs 260 protruding toward the first sidewall 202. The ribs 260 define a plurality of channels 262 that can extend in any suitable pattern partially or completely across the interior surfaces of the bag 200. As will be appreciated by those of skill in the art, the inclusion of channels 262 can direct air toward the valve element 230 from various regions within the bag 200 during evacuation. Furthermore, the channels 262 are preferably sized so that the flexible material comprising the sidewalls 202, 204 will not clog the channels or otherwise block the flow of air toward the valve even when the sidewalls are collapsed together. Of course, it should be further appreciated that alternatively the channels 262 could be defined by grooves formed into the interior surface instead of ribs. Additionally, the channels 262 can be defined in either or both of the sidewalls.

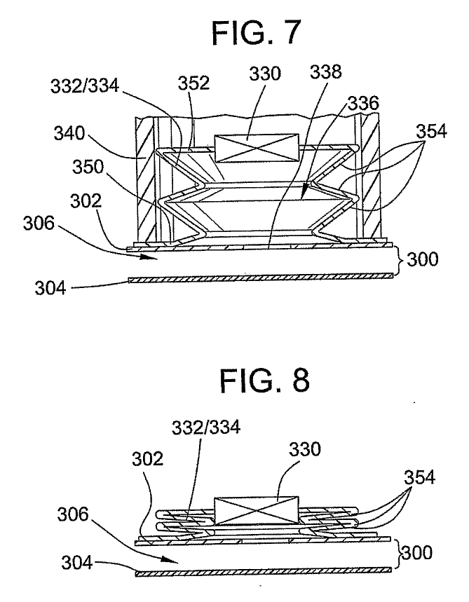

Illustrated in FIGS. 7 and 8 is another embodiment of a storage bag 300 wherein the separator 332 is shaped as a bellows 334 and formed separately from the material of the first sidewall 302. The bellows 334 is a generally cylindrical, thin-walled tube having an opened flanged base 350 and an opposing closed cap 352. The tubular bellows 334 defines and encloses a chamber 336 in which separation of fluids and juices from evacuating air can occur, as described above. A one-way valve element 330 is sealingly joined to the end cap 352. A plurality of annular pleats 354 are formed into the tubular sidewall which allow the bellows 334 to expand and contract with respect to the first sidewall 302. The bellows 334 can be made from any suitable material including, for example, high density polyethylene, low density polyethylene, polypropylene, ethylene vinyl acetate, and can be formed in single or multiple layers.

To operatively connect the bellows with the rest of the bag 300, the flanged base 350 is adjacent to the first sidewall 302 about a hole 338 disposed therein and attached to the first sidewall by adhesives or heat-sealing. When the separator 332 is in the collapsed position, as illustrated in FIG. 8, the chamber 336 is substantially eliminated and the valve element 330 is moved generally adjacent to the first sidewall 302. The separator 332 is collapsed by folding together the annular pleats 354 which create the bellows 334. Moreover, the first and second sidewalls 302, 304 can be flattened together to eliminate the interior volume 306. When the separator 332 is in the expanded position, as achieved in FIG. 7 by expanding the bellows 334, the chamber 336 is created and raises or spaces the valve element 332 away from the first sidewall 302. Air from the interior volume 306 can pass through the hole 338 to enter the chamber 336 where fluids and juices can separate out in the above-described manner. The air can then exit the chamber 336 through the one-way valve element 330. To expand the separator 332 for enlarging the chamber 336, a pressure differential can be applied across the first sidewall 302 by applying a nozzle 340 communicating with a vacuum source about the separator and valve element 330.

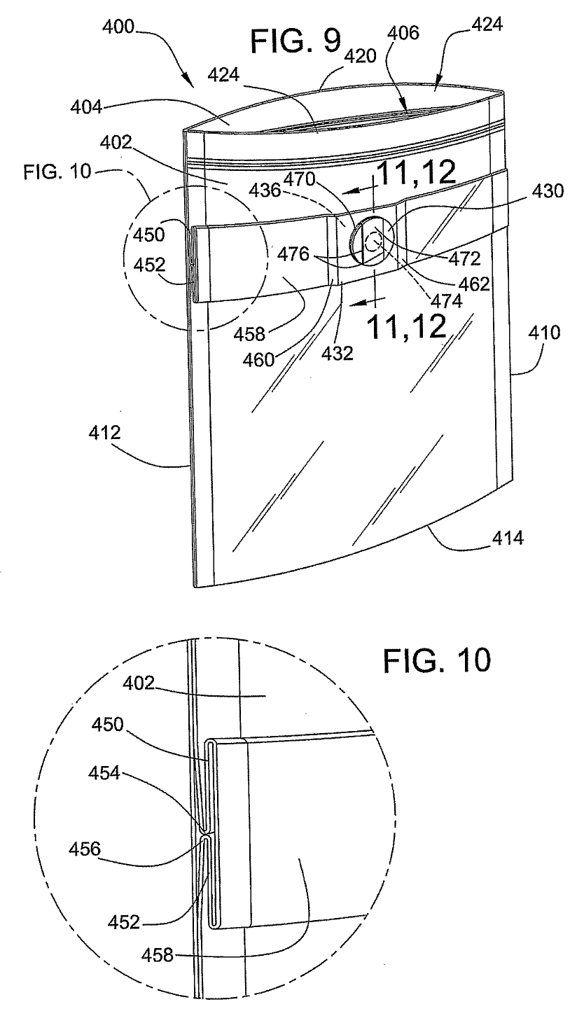

Referring to FIGS. 9 and 10, there is illustrated another embodiment of a storage bag 400 wherein the separator is formed integrally with the first sidewall. In the illustrated embodiment, the bag 400 is produced by joining together a first sidewall 402 and a second sidewall 404 along a sealed first side edge 410, a parallel sealed second side edge 412, and a closed bottom edge 414 extending between the first and second side edges to define an interior volume 406. To access the interior volume 406, the top edges 420, 422 of the first and second sidewalls 402, 404 are not joined together and thereby provide an opening 424.

As illustrated in FIGS. 9, 10, 11, and 12, to create the separator 432, first and second opposing Z-folds 450, 452 are formed into the first sidewall 402 and extend parallel to each other generally between the first and second side edges 410, 412. The first and second Z-folds 450, 452 are arranged to provide parallel, adjoining first and second bends 454, 456 and are interconnected by a continuous strip of material 458 that is slightly spaced-apart from the plane of the first sidewall 402 by the Z-folds. The adjoining bends 454, 456 are located beneath the strip 458 of material. Two parallel, spaced-apart seals 460, 462 are formed into the strip 458 approximately midway between the first and second side edges 410, 412 to outline the protruding, square-shaped separator 432. The separator 432 encloses and defines an expandable and collapsible chamber 436 in which separation of fluids and juices from evacuating air can occur. The one-way valve element 430 is sealingly joined to the separator 432 to communicate with the chamber 436.

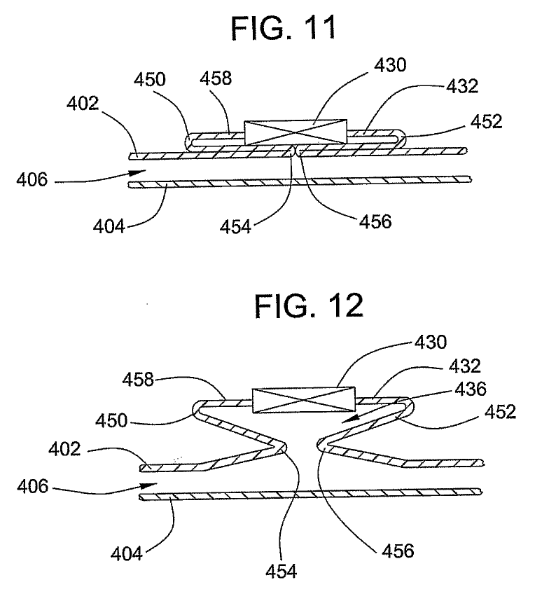

Referring to FIGS. 11 and 12, it will be appreciated that, during evacuation of the interior volume, air must pass between the adjoining bends 454, 456 of the Z-folds 450, 452 to enter the separator 432. Once in the separator 432, the evacuating air will cause the chamber 436 to expand by slightly raising the strip 458 with respect to the adjoining bends 454, 456. Fluids and juices can separate from the evacuating air inside the expanded chamber 436 in the above-described fashion and be returned to the interior volume 406 while the air exits through the one-way valve element 430.

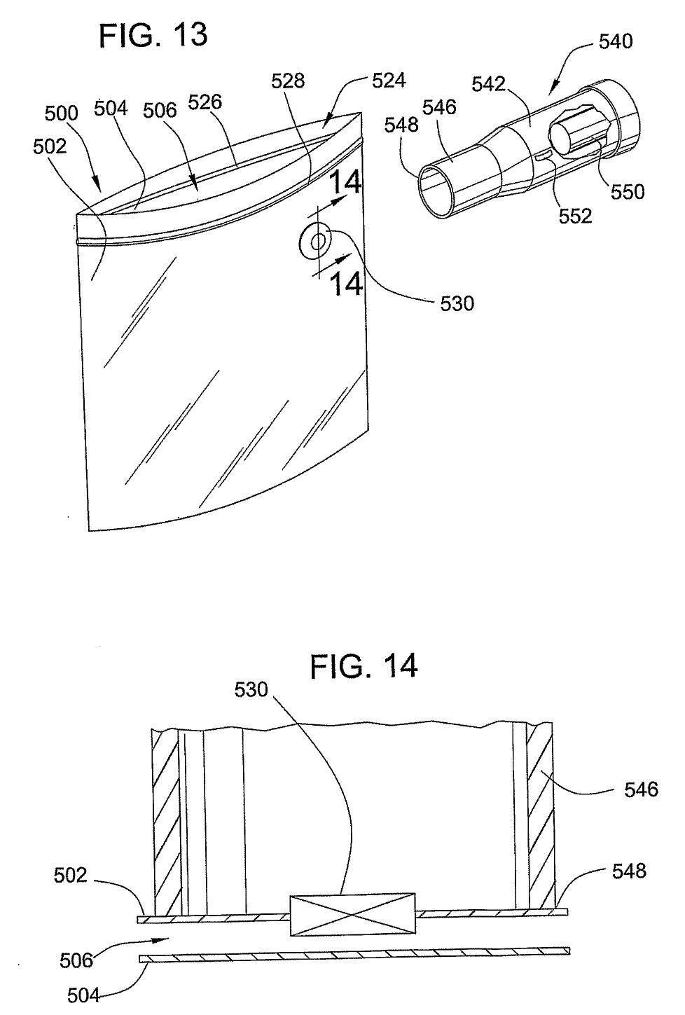

In another aspect, the invention provides an improved system and method for evacuating a storage bag. Referring to FIG. 13, the system involves a storage bag 500 made from a first sidewall 502 and an opposing second sidewall 504 overlaying and joined to the first sidewall to provide an interior volume 506. The first and second sidewalls 502, 504 are made from a pliable or flexible thin walled web or sheet of thermoplastic material. To access the interior volume 506, there is disposed along the top edge of the storage bag 500 an opening 524. To close the opening 524 and prevent spilling of the contents, first and second interlocking fastening strips 526, 528 can be attached to the interior surfaces of the first and second sidewalls 502, 504. In other embodiments, the opening 524 can be closed by adhesive bonding, a heat sealing operation, or by any other suitable method. To evacuate the interior volume 506 after closing the opening 524, as described above, the storage bag 500 can include a one-way valve element 530 attached to the first sidewall 502 and communicating with the interior volume.

To accomplish evacuation of the interior volume 506 through the valve element 530, the system also provides an evacuation device 540. In the illustrated embodiment, the evacuation device 540 is configured as a handheld device having an elongated housing 542 that can be made from a rigid material. The rigid material may be thermoplastic. The housing 542 tapers into a tubular nozzle 546 of which one end is formed as a circular inlet opening 548. Like the rest of the housing 542, the inlet opening 548 can also be made of a rigid material. The rigid material may be a thermoplastic. In another embodiment, the inlet opening may include a flexible gasket as shown in U.S. patent application No. 60/685,462 filed on May 27, 2005 (492.558, LVM 232460) herein incorporated by reference in its entirety. To actually generate suction at the inlet opening 548, the housing 542 may enclose an air flow generating unit 550 that communicates with the opening.

During evacuation, the inlet opening 548 is placed against the first sidewall 502 about the valve element 530. Activation of the evacuation device will cause the valve element to open while stopping or removing the evacuation device allows the valve element to close. To improve the interface between the valve element 530 and the evacuation device 540, as illustrated in FIG. 14, the inlet opening 548 is dimensioned and shaped to extend about the valve element and contact the pliable sidewall 502 directly. For example, the inlet opening 548 is dimensioned larger than the area of the valve element 530. In the illustrated embodiment, this can be accomplished by making the diameter of the circular inlet opening 548 larger than the corresponding diameter or width of the valve element 530. To simplify alignment and avoid interference between the nozzle 546 and the valve element 530, the inlet opening 548 may be dimensioned sufficiently larger the valve element. This may also allow the valve element to accommodate a range of different valve sizes.

When placed in contact together, the material of the pliable sidewall 502 can displace or be drawn against the rigid inlet opening 548 thereby sealing the interface between the valve element 530 and the evacuation device 540. Specifically, the pliable sidewall material can move or distort to block any leak paths or crevices existing along the rim of the rigid inlet opening. Such leak paths may otherwise remain exposed if the rigid inlet opening is placed directly against a rigid body of the valve element. As will be appreciated, sealing the interface between the valve element 530 and the evacuation device 540 with respect to the surrounding environment improves evacuation of the interior volume 506.

Referring back to FIG. 13, the air flow generating unit 550 can be electrically operated and can be activated by a switch 552 exposed on the exterior of the housing 502. Once activated, the airflow generating unit 550 will continue to draw air through the inlet opening 548 and thereby distinguishes the evacuation device 540 from hand operated pumps. Other advantages of using a continuously operating air flow generating unit include the improved speed of evacuation due to continuous operation and the ease of operator manipulation of the overall evacuation device.

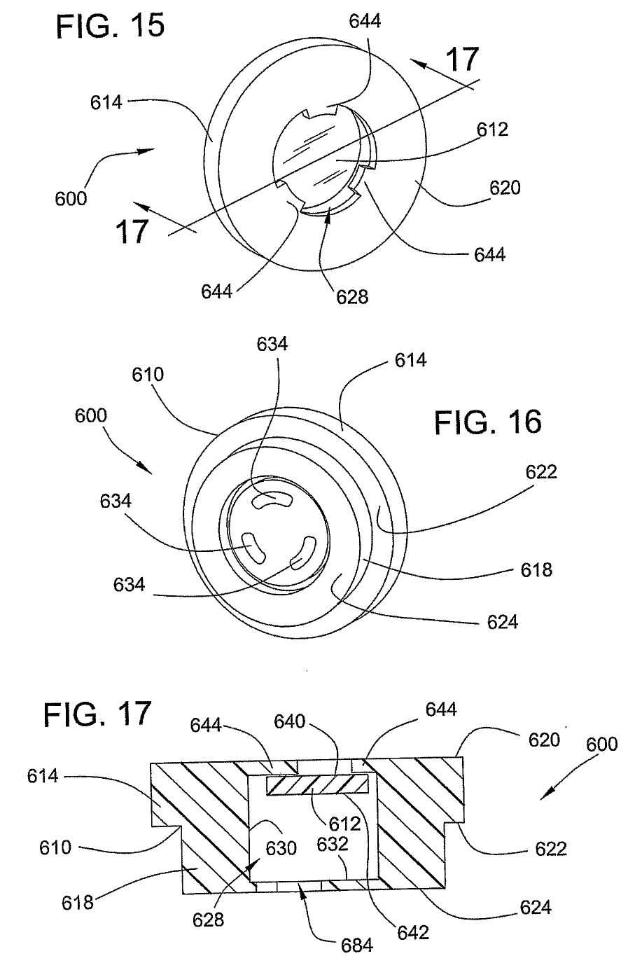

Referring to FIGS. 15, 16, and 17, the one-way valve element 600 for use with a storage bag of the foregoing type can include a rigid valve body 610 that cooperates with a movable disk 612 to open and close the valve element. The valve body 610 includes a circular flange portion 614 extending between parallel first and second flange faces 620, 622. Concentric to the flange portion 614 and projecting from the second flange face 622 is a circular boss portion 618 which terminates in a planar boss face 624 that is parallel to the first and second flange faces. The circular boss portion 618 is smaller in diameter than the flange portion 614 so that the outermost annular rim of the second flange face 622 remains exposed. The valve body 610 can be made from any suitable material such as a moldable thermoplastic material like nylon, HDPE, high impact polystyrene (HIPS), polycarbonates (PC), and the like.

Disposed concentrically into the valve body 610 is a counter-bore 628. The counter-bore 628 extends from the first flange face 620 part way towards the boss face 624. The counter-bore 628 defines a cylindrical bore wall 630. Because it extends only part way toward the boss face 624, the counter-bore 628 forms within the valve body 610 a preferably planar valve seat 632. To establish fluid communication across the valve body 610, there is disposed through the valve seat 632 at least one aperture 634. In fact, in the illustrated embodiment, a plurality of apertures 634 are arranged concentrically and spaced inwardly from the cylindrical bore wall 630.

To cooperatively accommodate the movable disk 612, the disk is inserted into the counter-bore 628. Accordingly, the disk 612 is preferably smaller in diameter than the counter-bore 628 and has a thickness as measured between a first disk face 640 and a second disk face 642 that is substantially less than the length of the counter-bore 628 between the first flange face 620 and the valve seat 632. To retain the disk 612 within the counter-bore 628, there is formed proximate to the first flange face 620 a plurality of radially inward extending fingers 644. The disk 612 can be made from any suitable material such as, for example, a resilient elastomer.

Referring to FIG. 17, when the disk 612 within the counter-bore 628 is moved adjacent to the fingers 644, the valve element 600 is in its open configuration allowing air to communicate between the first flange face 620 and the boss face 624. However, when the disk 612 is adjacent the valve seat 632 thereby covering the apertures 634, the valve element 600 is in its closed configuration. To assist in sealing the disk 612 over the apertures 634, a sealing liquid can be applied to the valve seat 632. Furthermore, a foam or other resilient member may be placed in the counter-bore 628 to provide a tight fit of the disk 612 and the valve seat 632 in the closed position.

To attach the valve element 600 to the first sidewall, referring to FIG. 16, an adhesive can be applied to the exposed annular rim portion of the second flange face 622. The valve element 600 can then be placed adjacent the exterior surface of the first sidewall with the boss portion 618 being received through the hole disposed into the sidewall and thereby pass into the internal volume. Of course, in other embodiments, adhesive can be placed on other portions of the valve element, such as the first flange face, prior to attachment to the sidewall.

In other embodiments, the one-way valve element can have a different construction. For example, the one-way valve element can be constructed from flexible film materials similar to those disclosed in U.S. Pat. No. 2,927,722, U.S. Pat. No. 2,946,502, and U.S. Pat. No. 2,821,338, all incorporated by reference in their entirety.

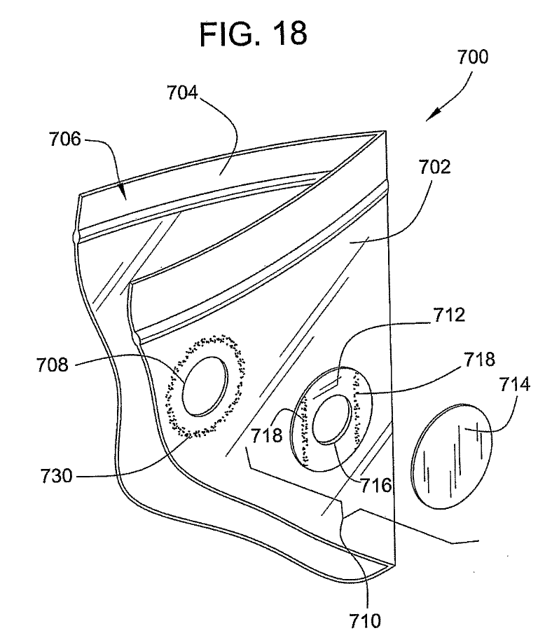

As illustrated in FIG. 18, such a flexible one-way valve element 710 made in accordance with this style can include a flexible, circular base layer 712 that cooperates with a correspondingly circular shaped, resilient top layer 714 to open and close the valve element. The top and bottom layers can be made from any suitable material such as, for example, a flexible thermoplastic film. Disposed through the center of the base layer 712 is an aperture 716, thus providing the base layer with an annular shape. The top layer 714 is placed over and adhered to the base layer 712 by two parallel strips of adhesive 718 that extend along either side of the aperture 716, thereby covering the aperture with the top layer and forming a channel. The base layer 712 is then adhered by a ring of adhesive 720 to the flexible bag 700 so as to cover the hole 708 disposed through the first sidewall 702.

As will be appreciated by those of skill in the art, when a pressure differential is applied across the valve element by, for example, placing the nozzle of an evacuation device adjacent the first sidewall 702 about the valve element, the top layer 714 can be partially displaced from the base layer 712 thereby exposing the aperture 716. Air from the interior volume 706 can pass through the hole 708 and aperture 716 and along the channel formed between the adhesive strips 718 where the removed air enters the evacuation device. When the suction force generate by the evacuation device is removed, the resilient top layer 714 will return to its prior configuration covering and sealing the aperture 716. The valve element 710 may also contain a viscous material such as an oil, grease, or lubricant between the two layers in order to prevent air from reentering the bag. In an embodiment, base layer 712 may also be a rigid sheet material.

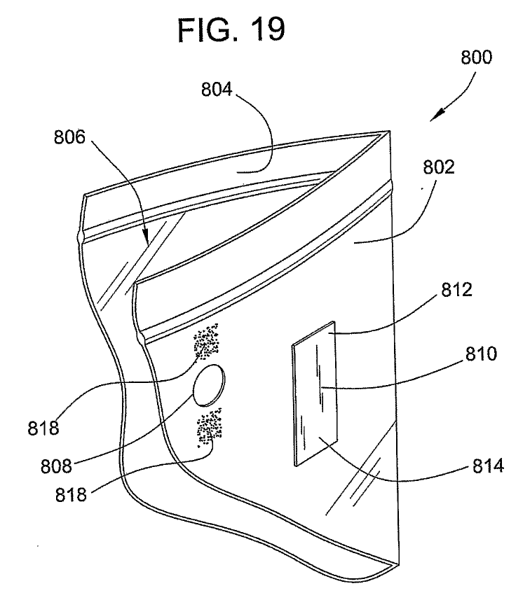

Illustrated in FIG. 19 is another embodiment of the valve element 810 that can be attached to the flexible plastic bag 800. The valve element 810 is a rectangular piece of flexible thermoplastic film that includes a first end 812 and a second end 814. The valve element 810 is attached to the first sidewall 802 so as to cover and seal a hole 808 disposed through the first sidewall. The valve element 810 can be attached to the sidewall 802 by patches of adhesive 818 placed on either side of the hole 808 so as to correspond to the first and second ends 812, 814. When the nozzle attached to an evacuation device is placed adjacent the first sidewall 802 about the valve element 810, air from the internal volume 806 displaces the flexible valve element 810 so as to unseal the hole 808. After evacuation of air from the internal volume 806, the valve element 810 will again cover and seal the hole 808.

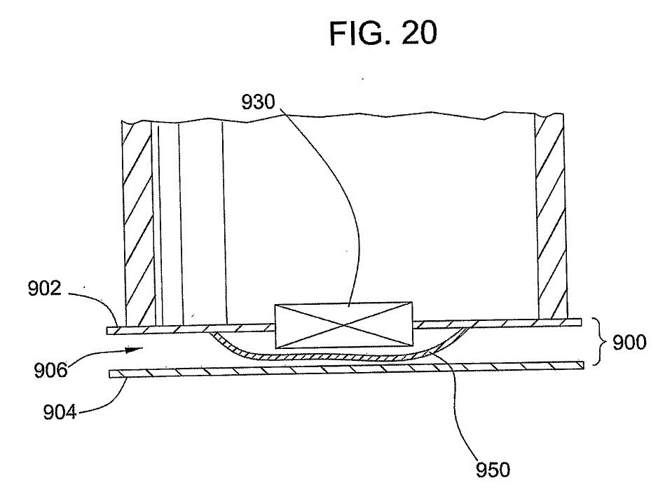

The storage bag can be configured with additional features for separating fluids and juices from air being evacuated through the one-way valve element. For example, as illustrated in FIG. 20, the storage bag 900 can include a non-woven or similar material that is provided as a barrier element 950. The non-woven material can be any suitable material such as, but not limited to, melt blown, spun bond, hydroentangled, needle punched, batting, dry-laid or wet-laid. The barrier element 950 is located within the bag 900 so as to separate that one-way valve element 930 from the interior volume 906 provided between the first and second sidewalls 902, 904. For instance, in the illustrated embodiment, the barrier element 950 can be attached to the inner surface of the first sidewall 902 so as to be drawn over and cover the valve element 930. In other embodiments, the barrier element 950 can be attached directly to the valve element 930 itself. As will be appreciated, air exhausting from the interior volume 906 will encounter the barrier element 950 prior to encountering the valve element 930. The non-woven or similar material of the barrier element 950 is permeable to the passage of air or other gases but resistive to the passage of fluids so that the barrier element can function to further separate fluids from the evacuating air. In various embodiments, the barrier element 950 can be treated with a hydrophobic or hydrophilic substance to further improve the fluid separation effect.

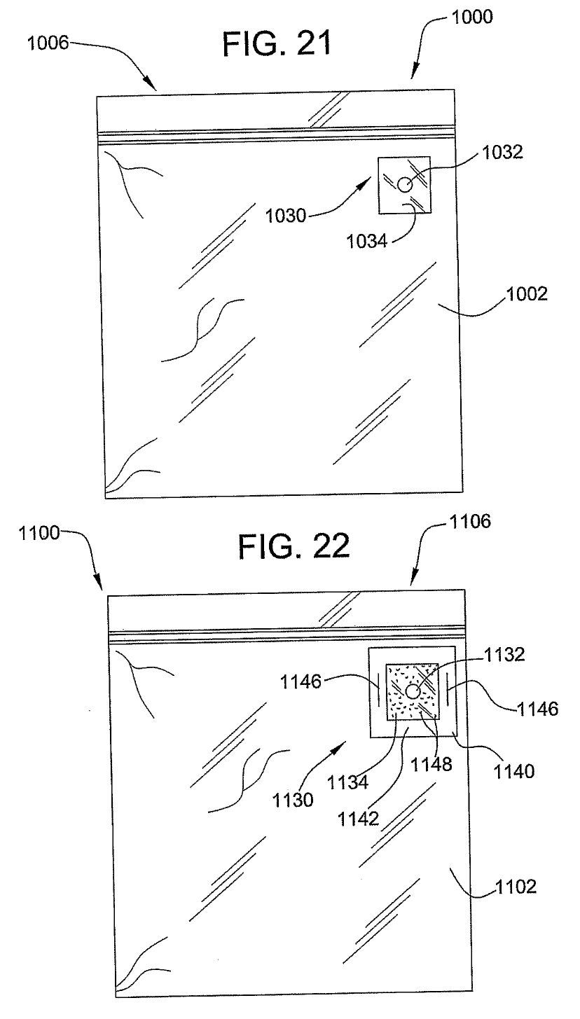

In other embodiments, the valve element can be comprised from a combination of porous and non-porous layers such as those disclosed in International patent application PCT/US2003/020478, filed on Jun. 27, 2003, and herein incorporated by reference in its entirety. A valve element 1030 of this type as attached to a storage bag 1000 is disclosed in FIG. 21. The valve element 1030 is provided over an aperture 1032 disposed into the first sidewall 1002 of the storage bag 1000 that communicates with the interior volume 1006. The valve element 1030 includes porous layer 1034 that is attached directly over the aperture 1032. To evacuate the interior volume 1006, the nozzle of an evacuation device can be placed adjacent the sidewall to draw air from the interior volume 1006 through both the porous layer 1034 and the aperture 1032. The porous layer 1034 can be made from any suitable material including, for example, a non-woven polymer such as spun bond, melt blown, or spun bond—melt blown—spun bond polyethylene. In other embodiments, the porous layer can be made from a foam material having an open cell structure such as foamed polyethylene.

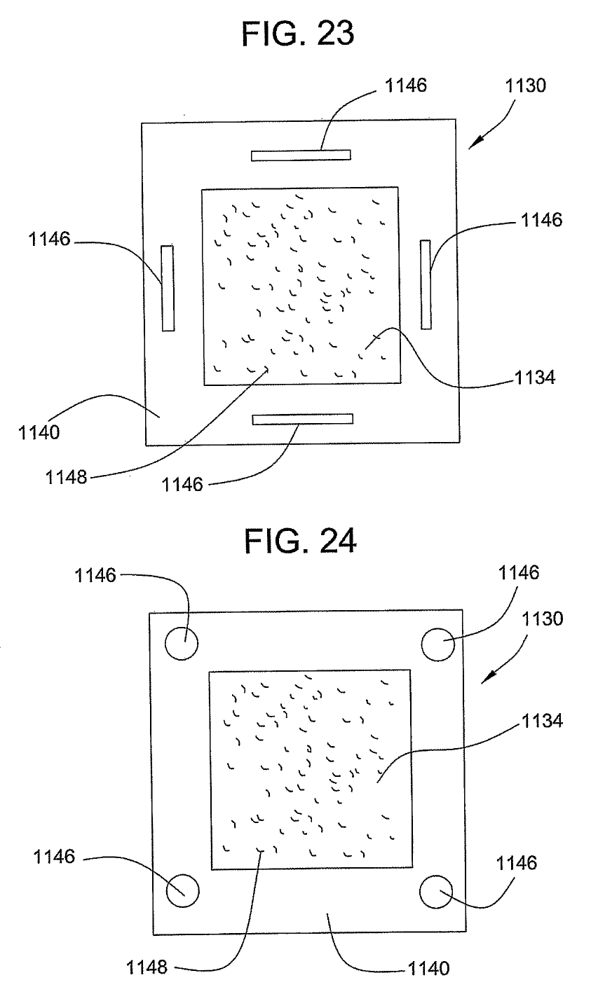

Referring to the storage bag 1100 illustrated in FIG. 22, in further embodiments, the valve element 1130 can also include a non-porous layer 1140 in addition to the porous layer 1134. The non-porous layer 1140 extends adjacently over the porous layer 1134 and is attached to the first sidewall 1102 by its peripheral edges 1142. Hence, the non-porous layer also extends over the aperture 1132. The non-porous layer 1140 also has disposed through it one or more perforations 1146. In the embodiment illustrated in FIG. 23 the perforations 1146 are straight slits in the side edges 1142 of the non-porous layer 1140 while in the embodiment illustrated in FIG. 24 the perforations are circular apertures disposed proximate the outer corners of the non-porous layer. When the storage bag 1100 is manipulated, excess air in the interior volume will pass through the aperture 1132 and the porous element 1134. The exiting air will displace the non-porous layer 1140 with respect to the porous layer 1134 and can thereby exit through the perforations 1140. After the excess air has exited, the non-porous layer 1140 can resiliently settle adjacent to the porous layer 1134 to close the aperture 1132.

A potential benefit of providing the non-porous layer 1140 is its ability to substantially prevent liquid within the interior volume from exiting the storage bag 1100. Specifically, if the liquid within the interior volume passes through the aperture 1132 and the porous layer 1134, it encounters the non-porous layer 1140. The liquid causes the porous layer 1134 and the non-porous layer 1140 to adhere together due to surface tension. As a result, the liquid cannot access the perforations 1146 to exit the storage bag. To further improve the liquid retaining features of the valve element, in other embodiments, the porous layer 1134 can include absorbent or super-absorbent particles 1148 disposed therein. Liquids entrained in excess air moving though porous layer 1134 will be absorbed by the particles 1148.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for storing food items or the like comprising in combination:
a storage bag including a flexible sidewall providing an interior volume and a one-way valve element attached to the flexible sidewall and communicating with the interior volume; and
an evacuation device including a housing having an inlet opening adapted to be placed adjacent the sidewall about the valve element.

2. The system of claim 1, wherein the inlet opening has a first diameter, and the valve element has a second diameter, the first diameter being larger than the second diameter.

3. The system of claim 1, wherein the evacuation device is configured for continuous operation when activated.

4. The system of claim 3, wherein the evacuation device includes an airflow generating unit.

5. The system of claim 4, wherein the airflow generating unit is enclosed in the housing.

6. The system of claim 1, wherein the housing and the inlet opening of the evacuation device are made from a rigid material.

7. (canceled)

8. The system of claim 1, wherein the storage bag includes an opening disposed through the side wall for accessing the interior volume.

9. The system of claim 8, wherein the storage bag includes a closure element for closing the opening; and
wherein the closure element includes first and second interlocking fastening strips.

10. (canceled)

11. The system of claim 1, wherein the valve element has a rigid valve body and a movable valve disk.

12. The system of claim 1, wherein the valve element has a flexible base layer attached over an aperture disposed through the sidewall and a top layer overlying the base layer.

13. The system of claim 1, wherein the storage bag includes a non-woven material covering the valve element for separating liquids from air.

14. The system of claim 13, wherein the non-woven material is located in the interior volume.

15. A method of evacuating a storage bag comprising:
(i) providing a storage bag including a flexible sidewall defining an interior volume, a sealable opening for accessing the interior volume, and a one-way valve element attached to the sidewall and communicating with the interior volume;
(ii) sealing the opening;
(iii) placing a nozzle of an evacuation device adjacent the sidewall about the valve element; and
(iv) evacuating the interior volume.

16. (canceled)

17. (canceled)

18. The method of claim 15, wherein the nozzle has a first diameter, and the valve element has a second diameter, the first diameter being larger than the second diameter.

19. The method of claim 15, further comprising the steps of:
(v) covering the valve element with a non-woven material; and
(vi) moving air from the interior volume through the non-woven material to separate liquids.

20. (canceled)

21. A system for storing food items or the like comprising in combination:
a storage bag including a flexible sidewall providing an interior volume;
a one-way valve element including a flexible first layer attached to the flexible sidewall and communicating with the interior volume; and
an evacuation device operative for fluid communication with the valve element.

22. The system of claim 21, wherein the storage bag includes an opening disposed through the sidewall for accessing the interior volume.

23. The system of claim 22, wherein the storage bag includes a closure element for closing the opening; and
wherein the closure element includes first and second interlocking fastening strips.

24. (canceled)

25. The system of claim 21, wherein the flexible first layer is attached over an aperture disposed through the sidewall and wherein the valve element further includes a second layer overlying the first layer.

26. The system of claim 25, wherein the second layer includes at least one perforation offset from the aperture.

27. A system for storing food items or the like comprising in combination:
a storage bag including a flexible sidewall providing an interior volume, the sidewall having an interior surface and an exterior surface;
a one-way valve element attached solely to the exterior surface of the flexible sidewall and communicating with the interior volume;
an evacuation device including a housing having an inlet opening adapted to be placed about the valve element for evacuating the internal volume via the one-way valve element; and wherein:
the one-way valve element extends above the interior surface when in a non evacuation condition.

28. The system of claim 27, wherein the storage bag includes an opening disposed through the sidewall for accessing the interior volume.

29. The system of claim 28, wherein the storage bag includes a closure element for closing the opening; and
wherein the closure element includes first and second interlocking fastening strips.

30. (canceled)

31. The system of claim 27, wherein the valve element has a flexible first layer attached over an aperture disposed through the sidewall and a second layer overlying the first layer.

32. The system of claim 32, wherein the second layer includes at least one perforation offset from the aperture.
